(19) United States
(12) Patent Application Publication
(10) Pub. No.: US 2013/0300985 A1
(43) Pub. Date: Nov. 14, 2013

(54) INTEGRATED PRIVACY FILTER

(71) Applicant: Marcus Bulda, Alameda, CA (US)

(72) Inventor: Marcus Bulda, Alameda, CA (US)

(21) Appl. No.: 13/471,285

(22) Filed: May 14, 2012

(51) Int. Cl. G02F 1/1335; G02F 1/1334; G02B 27/00

(52) U.S. Cl. 349/86; 359/613; 349/104

(57) ABSTRACT

An integrated privacy filter comprises a multilayer display portion comprising a panel comprising a front display surface. The multilayer display portion further comprises a native viewing angle. An electronically activated material layer is disposed above the front display surface to substantially cover at least an active display area of the multilayer display portion in which the electronically activated material layer is integrated with the multilayer display portion and activation of the electronically activated material layer alters the native viewing angle. A touch screen portion is disposed above the electronically activated material layer. The touch screen portion is configured to at least react to touch inputs from a user and to substantially cover the active display area.

### CROSS-REFERENCE TO RELATED APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to computing devices with screens for presentation. More particularly, one or more embodiments of the invention relate to systems with privacy filters associated with viewing information.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Touch-screen monitors are often configured for resistive, capacitive or surface acoustic wave operation. Resistive systems typically use a glass panel that is covered with a conductive and a resistive metallic layer. An electrical current traverses the conductive and resistive metallic layers and when a user touches the screen, the two layers make contact at the point of contact, and based upon the change in the electrical field the location associated with the touch may be determined. Capacitive systems are typically configured with a layer that stores an electrical charge that is placed on the glass panel of the monitor. When the monitor is touched, charge is transferred to the user such that the charge on the capacitive layer decreases which can be detected and used to determine location. Surface acoustic wave systems typically use two transducers, one for receiving and one for transmitting. The transducers are located along the axes of the monitor's glass plate and the receiving transducer is able to detect a disturbance associated with a touch and they system is able to determine the location associated with the touch.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a side view of an example computing device, in accordance with an embodiment of the present invention;

FIG. 2A is an exploded side view of a conventional privacy screen device;

FIG. 2B is an exploded side view of a privacy screen device, in accordance with an embodiment of the present invention;

FIG. 3 illustrates a block diagram of an embodiment of an electronic system having a processing device for detecting a presence of a conductive object, in accordance with an embodiment of the present invention;

FIGS. 4A-B illustrates cross-sectional view of a touch-screen display device, in accordance with an embodiment of the present invention;

FIG. 5 is an exploded perspective view illustrating an exemplary touch-screen display device, in accordance with an embodiment of the present invention;

FIG. 6 is a plan view illustrating a portion of the exemplary touch-screen display device shown in FIG. 5, in accordance with an embodiment of the present invention;

FIG. 7 is a perspective view illustrating an exemplary touch-screen display device, in accordance with an embodiment of the present invention;

FIGS. 8A-C illustrate an exemplary “OK gesture” for performing recognition, in accordance with an embodiment of the present invention;

FIG. 9 illustrates an alternative embodiment of the privacy filter described with reference to FIG. 2, in accordance with an embodiment of the present invention;

FIG. 10 illustrates an exaggerated, cross-sectional, perspective view of the film described with reference to FIG. 9, in accordance with an embodiment of the present invention; and

FIG. 11 illustrates a typical computer system that, when appropriately configured or designed, may serve as a computer system for which the present invention may be embodied.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

A non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; however, the non-transitory computer readable medium does not include a pure transitory signal per se.

Systems will be described which provides means and method for providing a privacy filter associated with viewing information. Privacy filter enables viewing for a subset of angles available to user. Furthermore, viewing angle may be configured by user. In some embodiments, privacy filter may be configured for activation or inactivation. Non-limiting examples for configuring privacy filter include touch, button, application and device settings. Privacy filter may be located below touch-screen detection circuitry thereby reducing interference associated with implementing privacy filters as compared to conventional systems. Privacy filter may be implemented for multi-touch systems. Furthermore, privacy filter may be implemented for navigation using hand gestures.

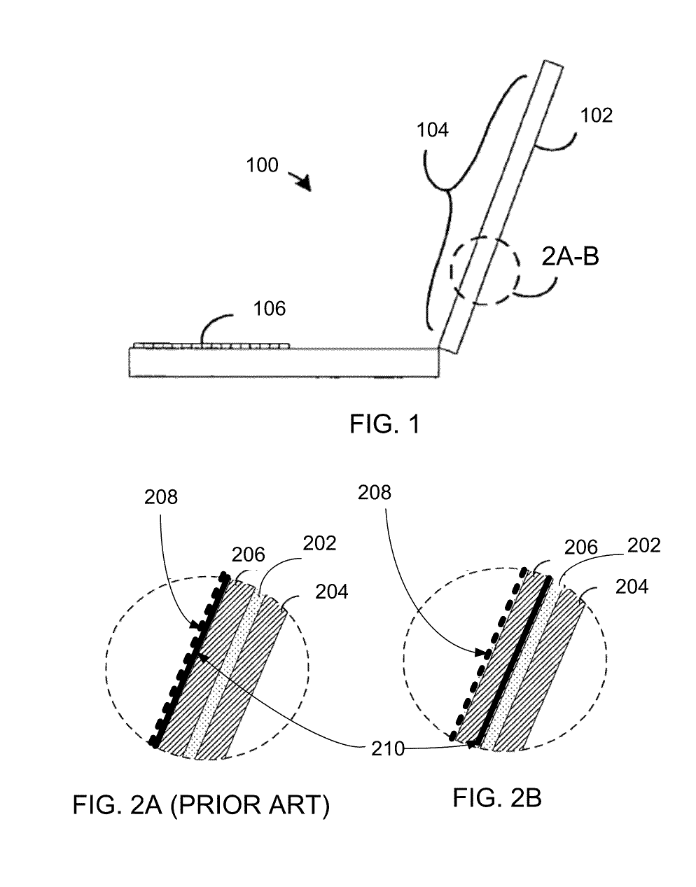

The privacy filter system will now be described in detail with reference to FIGS. 1-11.

FIG. 1 is a side view of an example computing device, in accordance with an embodiment of the present invention.

FIG. 2A is an exploded side view of a conventional privacy screen device.

FIG. 2B is an exploded side view of a privacy screen device, in accordance with an embodiment of the present invention.

With reference to FIG. 1 and FIGS. 2A-B, a device 100 includes a touch screen display 102 having an electronic privacy filter 104. As a non-limiting example, device 100 may be processor-based and electronic privacy filter may be integrated with device 100.

Device 100 receives, transmits, stores, processes and presents information in a private or non-private manner Electronic privacy filter 104 prevents viewing information from a certain angle with respect to the center of electronic privacy filter 104.

Device 100 may include an input device 106 (e.g. a keyboard). The user may control the mode of the electronic privacy filter 104 from the input device 106, e.g. with software running on the device 100. In some examples, an electronic view adjustment layer or layers may be added, e.g. as a film, to the touch screen display 102 as part of the manufacturing process for the touch screen display 102. For example, without limitation, the view adjustment layers may change a polarization or otherwise adjust a perceived viewing angle for the display. Advantageously, adding the electronically controlled privacy layers may represent little or no additional cost as compared to conventional flat panel displays with multiple passive layers.

For example, without limitation, the touch screen display 102 includes a touch screen 208, a multilayer LCD screen with of a base set of layers noted as a layer 202, a layer 204, and a layer 206 which provide a native viewing angle. Electronic privacy filter 104 may include an additional layer or set of layers noted as a layer 210 of electronically activated material, which can be electronically activated to adjust the perceived viewing angle for the touch screen display 102 to be different from the native viewing angle. Layer 210 may be configured as in FIG. 2A (PRIOR ART) located above layer 206, or as in FIG. 2B, as a non-limiting example, below layer 206. Electronic privacy filter 104 may then include viewing angle enhancement material to selectively increase the perceived viewing angle of the touch screen display 102. For example, without limitation, a Polymer Dispersed Liquid Crystal (PDLC) material utilized in the set of layers 210 on the touch screen display 102 may provide a dispersive effect on the underlying image to selectively increase the perceived viewing angle for the touch screen display 102.

In another example, the LCD screen may include passive films or filters to provide a relatively wide viewing angle. For example, without limitation, many conventional laptop display include multiple passive layers to increase the perceived viewing angle of the display. Electronic privacy filter 104 may then include viewing angle restrictive material to selectively decrease the perceived viewing angle of the touch screen display 102. For example, without limitation, a Twisted Nematic (TN) liquid crystal material utilized in the set of layers 210 on the touch screen display 102 may provide a polarizing effect on the underlying image to selectively decrease the perceived viewing angle for the touch screen display 102.

The relatively more private and public modes may correspond to the respective viewing angles of the display image. In the private mode, the visibility of the display corresponds to the relatively narrow viewing angle of the underlying base set of layers. In the public mode, the visibility of the display corresponds to a relatively wider viewing angle provided the view angle enhancement material. Switching between modes is electronically controlled and the user can switch modes without applying external devices in order to configure for privacy operation.

Power for the view angle enhancement layer(s) may be drawn from the processor-based device 100. For example, without limitation, DC power may be provided from the battery of a laptop computer. Alternatively, when the laptop is plugged in for charging, power may be provided from the AC adapter or from the power conversion circuit within the laptop. A set of appropriate electrical contacts or electrodes are provided for the layer(s) as may be needed by the particular material utilized for the view angle enhancement. Indium titanium oxide (ITO) is a transparent conductive material that may be suitable for either common electrodes or electrode arrays (e.g. individual electrodes corresponding to pixel locations).

Advantageously, in some embodiments, little or no power is drawn by the electronic privacy filter 104 in private mode. Accordingly, private mode may provide a power savings in many situations where private mode may be needed, such as when using a laptop computer on battery power in a public place, such as an airport or airplane. Conversely, in some embodiments, public mode may be needed in situations where AC power is available, such as when using the processor-based device in a meeting at a conference room.

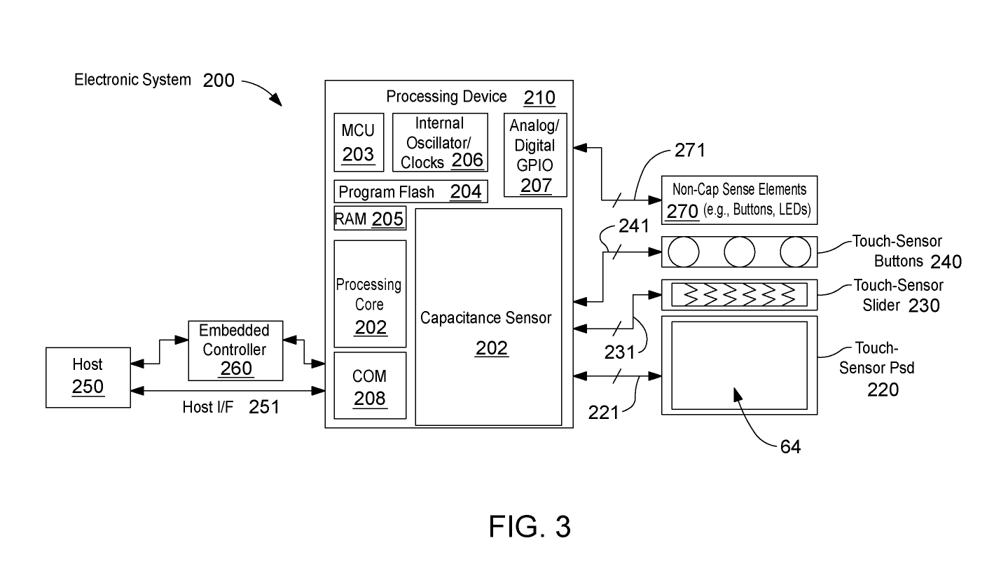

FIG. 3 illustrates a block diagram of an embodiment of an electronic system having a processing device for detecting a presence of a conductive object, in accordance with an embodiment of the present invention.

An electronic system 300 includes electronic privacy filter 104, a processing device 318, a touch-sensor pad 322, a touch-sensor slider 328, a touch-sensor buttons portion 334, a host processor 340, an embedded controller 341, and a non-capacitance sensor elements portion 350. The processing device 318 may include an analog and/or digital general purpose input/output (“GPIO”) ports portion 314. GPIO ports portion 314 may be programmable. GPIO ports portion 314 may be coupled to a Programmable Interconnect and Logic (“PIL”), which acts as an interconnect between GPIO ports portion 314 and a digital block array of the processing device 318 (not illustrated). The digital block array may be configured to implement a variety of digital logic circuits (e.g., DAC, digital filters, digital control systems) using, in one embodiment, configurable user modules (“UMs”). The digital block array may be coupled to a system bus (not illustrated). Processing device 318 may also include memory, such as a random access memory (RAM) 310 and a program flash 308. RAM 310 may be static RAM (SRAM) or the like, and program flash 308 may be a non-volatile storage, or the like, which may be used to store firmware (e.g., control algorithms executable by a processing core 304 to implement described operations). Processing device 318 may also include a memory controller unit (MCU) 306 coupled to memory and the processing core 304.

The processing device 318 may also include an analog block array (not illustrated). The analog block array is also coupled to the system bus. Analog block array also may be configured to implement a variety of analog circuits (e.g., ADC, analog filters) using, in one embodiment, configurable UMs. The analog block array may also be coupled to the GPIO portion 314.

As illustrated, a capacitance sensor 302 may be integrated into processing device 318. Capacitance sensor 302 may include analog I/O for coupling to an external component, such as touch-sensor pad 322, touch-sensor slider 328, touch-sensor buttons portion 334, and/or other devices. Capacitance sensor 302 and processing device 318 are described in more detail below.

It should be noted that the embodiments described are not limited to touch-sensor pads for notebook implementations, but can be used in other capacitive sensing implementations, for example, without limitation, the sensing device may be a touch screen, touch-sensor slider 328, or touch-sensor buttons portion 334 (e.g., capacitance sensing button). It should also be noted that the embodiments described may be implemented in other sensing technologies than capacitive sensing, such as resistive, optical imaging, surface acoustical wave (SAW), infrared, dispersive signal, and strain gauge technologies. Similarly, the operations described are not limited to notebook pointer operations, but can include other operations, such as lighting control (dimmer), temperature or environmental control, volume control, graphic equalizer control, speed control, or other control operations requiring gradual or discrete adjustments. It should also be noted that these embodiments of capacitive sensing implementations may be used in conjunction with non-capacitive sensing elements, including but not limited to pick buttons, sliders (ex. display brightness and contrast), scroll-wheels, multi-media control (ex. volume, track advance, etc.) handwriting recognition and numeric keypad operation.

In some embodiments, the electronic system 300 includes touch-sensor pad 322 coupled to the processing device 318 via a bus 324. Touch-sensor pad 322 may include a two-dimension sensor array. The two-dimension sensor array includes multiple sensor elements, organized as rows and columns In another embodiment, the electronic system 300 includes touch-sensor slider 328 coupled to the processing device 318 via a bus 330. Touch-sensor slider 328 may include a single-dimension sensor array. The single-dimension sensor array includes multiple sensor elements, organized as rows, or alternatively, as columns. In other embodiments, the electronic system 300 includes touch-sensor buttons portion 334 coupled to the processing device 318 via a bus 336. Touch-sensor buttons portion 334 may include a single-dimension or multi-dimension sensor array. The single- or multi-dimension sensor array includes multiple sensor elements. For a touch-sensor button, the sensor elements may be coupled together to detect a presence of a conductive object over the entire surface of the sensing device. Alternatively, the touch-sensor buttons portion 334 has a single sensor element to detect the presence of the conductive object. In one embodiment, the touch-sensor buttons portion 334 may be a capacitance sensor element. Capacitance sensor elements may be used as non-contact sensors. These sensor elements, when protected by an insulating layer, offer resistance to severe environments.

The electronic system 300 may include any combination of one or more of the touch-sensor pad 322, touch-sensor slider 328, and/or touch-sensor buttons portion 334. In other embodiments, the electronic system 300 may also include non-capacitance sensor elements portion 350 coupled to the processing device 318 via a bus 352. The non-capacitance sensor elements portion 350 may include buttons, light emitting diodes (LEDs), and other user interface devices, such as a mouse, a keyboard, a display, or other functional keys that do not require capacitance sensing. In one embodiment, buses 352, 336, 330, and 324 may be a single bus. Alternatively, these buses may be configured into any combination of one or more separate buses.

The processing device 318 may also provide value-added functionality such as keyboard control integration, LEDs, battery charger and general purpose I/O, as illustrated as non-capacitance sensor elements portion 350. Non-capacitance sensor elements portion 350 are coupled to GPIO portion 314.

Processing device 318 may include an oscillator/clocks portion 312 and a communication portion 316. The oscillator/clocks portion 312 provides clock signals to one or more of the components of processing device 318. Communication portion 316 may be used to communicate with an external component, such as host processor 340, via a host interface 342. Alternatively, processing device 318 may also be coupled to embedded controller 341 to communicate with the external components, such as host processor 340. Interfacing to the host processor 340 can be through various methods. In one embodiment, interfacing with the host processor 340 may be done using a standard PS/2 interface to connect to embedded controller 341, which in turn sends data to the host processor 340 via a low pin count (LPC) interface. In some instances, it may be beneficial for the processing device 318 to do touch-sensor pad and keyboard control operations, thereby freeing up the embedded controller 341 for other housekeeping functions. In other embodiments, interfacing may be performed using a universal serial bus (USB) interface directly coupled to the host processor 340 via host interface 342. Alternatively, the processing device 318 may communicate to external components, such as the host processor 340 using industry standard interfaces, such as USB, PS/2, inter-integrated circuit (12C) bus, or system packet interfaces (SPI). The host processor 340 and/or embedded controller 341 may be coupled to the processing device 318 with a ribbon or flex cable from an assembly, which houses the sensing device and processing device.

In some embodiments, the processing device 318 may be configured to communicate with the embedded controller 341 or the host processor 340 to send and/or receive data. The data may be a command or alternatively a signal. In some embodiments, the electronic system 300 may operate in standard-mouse compatible and enhanced modes. The standard-mouse compatible mode utilizes the Human Interface Device (HID) class drivers already built into the Operating System (OS) software of host processor 340. These drivers enable the processing device 318 and sensing device to operate as a standard pointer control user interface device, such as a two-button PS/2 mouse. The enhanced mode may enable additional features such as scrolling or disabling the sensing device, such as when a mouse is plugged into the notebook. Alternatively, the processing device 318 may be configured to communicate with the embedded controller 341 or the host processor 340, using non-OS drivers, such as dedicated touch-sensor pad drivers, or other drivers known by those of ordinary skill in the art.

In other embodiments, the processing device 318 may operate to communicate data (e.g., commands or signals) using hardware, software, and/or firmware, and the data may be communicated directly to the processing device of the host processor 340, such as a host processor, or alternatively, may be communicated to the host processor 340 via drivers of the host processor 340, such as OS drivers, or other non-OS drivers. It should also be noted that the host processor 340 may directly communicate with the processing device 318 via host interface 342.

In other embodiments, non-limiting examples for the data sent to the host processor 340 from the processing device 318 includes click, double-click, movement of the pointer, scroll-up, scroll-down, scroll-left, scroll-right, step Back, and step Forward. In other embodiments, non-limiting examples for the data sent to the host processor 340 include the position or location of the conductive object on the sensing device. Alternatively, other user interface device commands may be communicated to the host processor 340 from the processing device 318. These commands may be based on gestures occurring on the sensing device that are recognized by the processing device. Non-limiting examples of gestures include tap, push, hop, drag, and zigzag gestures. Alternatively, other commands may be recognized. Similarly, signals may be sent that indicate the recognition of these operations.

In particular, a tap gesture, as a non-limiting example, may be when the finger (e.g., conductive object) is placed upon the sensing device for less than a threshold time. If the time the finger is placed upon the touchpad is greater than the threshold time it may be considered to be a movement of the pointer, in the x- or y-axes. As non-limiting examples, scroll-up, scroll-down, scroll-left, and scroll-right, step back, and step-forward may be detected when the absolute position of the conductive object is within a pre-defined area, and movement of the conductive object is detected.

Processing device 318 may reside on a common carrier substrate such as, for a non-limiting example, an integrated circuit (IC) die substrate, a multi-chip module substrate, or the like. Alternatively, the components of processing device 318 may be one or more separate integrated circuits and/or discrete components. Alternatively, processing device 318 may be one or more other processing devices known by those of ordinary skill in the art. Non-limiting examples of processing devices include a microprocessor or central processing unit, a controller, special-purpose processor, digital signal processor (DSP), an application specific integrated circuit (ASIC), a field programmable gate array (FPGA), or the like. In an alternative embodiment, for example, without limitation, the processing device may be a network processor having multiple processors including a core unit and multiple micro-engines. Additionally, as a non-limiting example, the processing device may include any combination of general-purpose processing device(s) and special-purpose processing device(s).

It should also be noted that the embodiments described are not limited to having a configuration of a processing device coupled to a host, but may include a system that measures the capacitance on the sensing device and sends the raw data to a host computer where it is analyzed by an application. In effect the processing that is performed by processing device 318 may also be performed in the host. In other embodiments, the processing device 318 may be configured as the host.

In other embodiments, the method and apparatus described may be implemented in a fully self-contained touch-sensor pad, which communicates fully processed x/y movement and gesture data signals or data commands to a host. In other embodiments, the method and apparatus may be implemented in a touch-sensor pad, which outputs x/y movement data and also finger presence data to a host, and where the host processes the received data to detect gestures. In other embodiments, the method and apparatus may be implemented in a touch-sensor pad, which outputs raw capacitance data to a host, where the host processes the capacitance data to compensate for quiescent and stray capacitance, and calculates x/y movement and detects gestures by processing the capacitance data. Alternatively, the method and apparatus may be implemented in a touch-sensor pad, which outputs pre-processed capacitance data to a host, where the touchpad processes the capacitance data to compensate for quiescent and stray capacitance, and the host calculates x/y movement and detects gestures from the pre-processed capacitance data.

In other embodiments, the electronic system that includes the embodiments described may be implemented in a conventional laptop touch-sensor pad. Alternatively, it may be implemented in a wired or wireless keyboard integrating a touch-sensor pad. Furthermore, the touch-sensor pad itself connected to a host. In such an implementation, the processing described above as being performed by the “host” may be performed in part or in whole by the keyboard controller, which may then pass fully processed, pre-processed or unprocessed data to the system host. In other embodiments, features may be implemented in a mobile handset (e.g., cellular or mobile phone) or other electronic devices where the touch-sensor pad may operate in one of two or more modes. For example, without limitation, the touch-sensor pad may operate either as a touch-sensor pad for x/y positioning and gesture recognition, or as a keypad or other arrays of touch-sensor buttons and/or sliders. Alternatively, the touch-sensor pad, although configured to operate in the two modes, may be configured to be used as a keypad.

Capacitance sensor 302 may be integrated into the processing device 318, or alternatively, in a separate IC. Alternatively, descriptions of capacitance sensor 302 may be generated and compiled for incorporation into other integrated circuits. As a non-limiting example, behavioral level code describing capacitance sensor 302, or portions thereof, may be generated using a hardware description language, such as VHDL or Verilog, and stored to a machine-accessible medium (e.g., Flash ROM, CD-ROM, hard disk, floppy disk, etc.). Furthermore, the behavioral level code can be compiled into register transfer level (“RTL”) code, a netlist, or even a circuit layout and stored to a machine-accessible medium. The behavioral level code, the RTL code, the netlist, and the circuit layout represent various levels of abstraction to describe capacitance sensor 302.

It should be noted that the components of electronic system 300 may include the components described above. Alternatively, electronic system 300 may include a subset of the components described above, or include additional components not listed.

While the embodiment shown for electronic system 300 is shown used in a notebook computer, those skilled in the art will readily recognize that the novel teachings may be applied to a multiplicity of alternative, suitable, electronic graphical display applications requiring improved privacy filtering and touch screen input functionality. By way of example, and not limitation, suitable alternative applications may include electronic device such as such as a Smartphone, mobile handset, a personal data assistant (PDA), a kiosk, a keyboard, a television, a remote control, a monitor, a handheld multi-media device, a handheld video player, a handheld gaming device, or a control panel.

In other embodiments, capacitance sensor 302 may be a capacitive sense relaxation oscillator (CSR). The CSR may be coupled to an array of sensor elements using a current-programmable relaxation oscillator, an analog multiplexer, digital counting functions, and high-level software routines to compensate for environmental and physical sensor element variations. The sensor array may include combinations of independent sensor elements, sliding sensor elements (e.g., touch-sensor slider), and touch-sensor sensor element pads (e.g., touch pad or touch screen) implemented as a pair of orthogonal sliding sensor elements. The CSR may include physical, electrical, and software components. The physical components may include the physical sensor element itself, typically a pattern constructed on a printed circuit board (PCB) with an insulating cover, a flexible membrane, or a transparent overlay. The electrical component may include an oscillator or other means to convert a capacitance into a measured value. The electrical component may also include a counter or timer to measure the oscillator output. The software component may include detection and compensation algorithms to convert the count value into a sensor element detection decision (also referred to as switch detection decision). For example, without limitation, in the case of slider sensor elements or X-Y touch-sensor sensor element pads, a calculation for finding position of the conductive object to greater resolution than the physical pitch of the sensor elements may be used.

It should be noted that there are various known methods for measuring capacitance. Although some embodiments are described using a relaxation oscillator, the present embodiments are not limited to using relaxation oscillators, but may include other methods. Non-limiting examples of other methods for measuring capacitance include current versus voltage phase shift measurement, resistor-capacitor charge timing, capacitive bridge divider, charge transfer, sigma-delta modulators, charge-accumulation circuits, or the like.

As a non-limiting example, the current versus voltage phase shift measurement may include driving the capacitance through a fixed-value resistor to yield voltage and current waveforms that are out of phase by a predictable amount. The drive frequency can be adjusted to keep the phase measurement in a measured range. The resistor-capacitor charge timing may include charging the capacitor through a fixed resistor and measuring timing on the voltage ramp. Small capacitance values may require large resistors for reasonable timing The capacitive bridge divider may include driving the capacitor under test through a fixed reference capacitor. The reference capacitor and the capacitor under test form a voltage divider. The voltage signal may be recovered with a synchronous demodulator, which may be done in the processing device 318. The charge transfer may be conceptually similar to an R-C charging circuit. In this method, CP is the capacitance being sensed. CSUM is the summing capacitor, into which charge is transferred on successive cycles. At the start of the measurement cycle, the voltage on CSUM is discharged. The voltage on CSUM increases exponentially per clock cycle. The time needed for this voltage to reach a specific threshold is measured with a counter. Additional details regarding these alternative embodiments have not been included so as to not obscure the present embodiments, as these alternative embodiments for measuring capacitance are known by those of ordinary skill in the art.

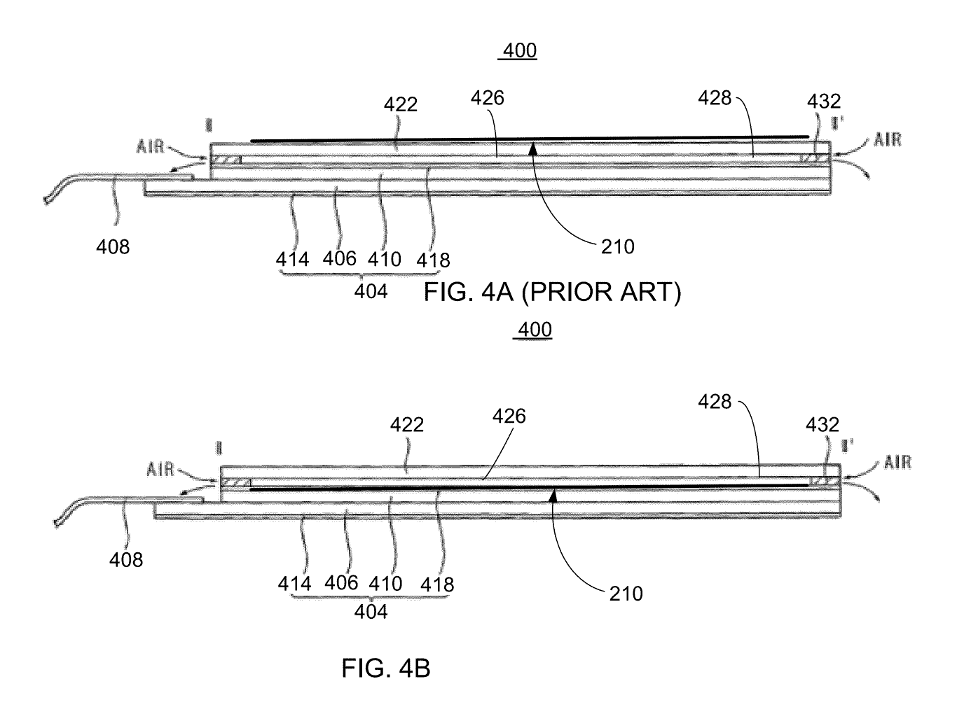

FIGS. 4A-B illustrates cross-sectional view of a touch-screen display device, in accordance with an embodiment of the present invention.

Referring to FIGS. 4A-B, a touch-screen display device 400 includes a display panel 404, a touch panel 422, a first polarization film 414, a second polarization film 418, an adhesive member 426, layers 210 and a flexible printed circuit board 408. Layers 210 may be configured on top of touch panel 422 as illustrated in FIG. 4A (PRIOR ART) or as a non-limiting example below touch panel 422, as illustrated in FIG. 4B.

Accordingly, a first substrate 406, a second substrate 410, and the second polarization film 418 are sequentially disposed on the first polarization film 414, and the liquid crystal layer is interposed between the first substrate 406 and second substrate 410.

The touch panel 422 is disposed separately from the second polarization film 418.

The adhesive member 426 is disposed between the second polarization film 418 and the touch panel 422 in correspondence to a peripheral area PA that is defined in the display panel 404.

The adhesive member 426 includes an adhesive part 428 and an airing portion 432.

The adhesive part 428 includes, for example, without limitation, an adhesive tape or film. When the adhesive part 428 includes an adhesive tape or film, two central portions of the adhesive part 428 corresponding to the peripheral long sides of the display panel 404 are removed. Accordingly, an opening portion that is connected through the touch panel 422 and the display panel 404 is formed in the adhesive part 428. In other words, the adhesive part 428 may include two substantially U-shaped sections that are spaced apart at end portions thereof to form the opening portions there between. Alternative numbers of sections may also be provided to provide an alternative number of opening portions between the end portions of the sections of the adhesive part 428. The adhesive part 428 may also include a bonding agent selectively applied to portions of the peripheral area PA, while not applying the bonding agent to certain portions of the peripheral area PA to correspond to opening portions between the applied portions.

The airing portion 432 may include an airing tissue. For example, without limitation, the airing portion 432 may be a non-woven fabric. Airing portion 432 may be disposed in the peripheral area PA where the adhesive part 428 is opened. That is, the airing portion 432 may be positioned within the opening portions formed between end portions of the adhesive part 428. Accordingly, the airing portion 432 makes contact with the touch panel 422 and the display panel 404. In the illustrated embodiment, the adhesive part 428 and the airing portion 432 are formed on the same layer of the touch-screen display device 400. Edges of the end portions of the adhesive part 428 and the airing portion 432 may contact. Therefore, the display panel 404 is separated by a predetermined interval from the touch panel 422.

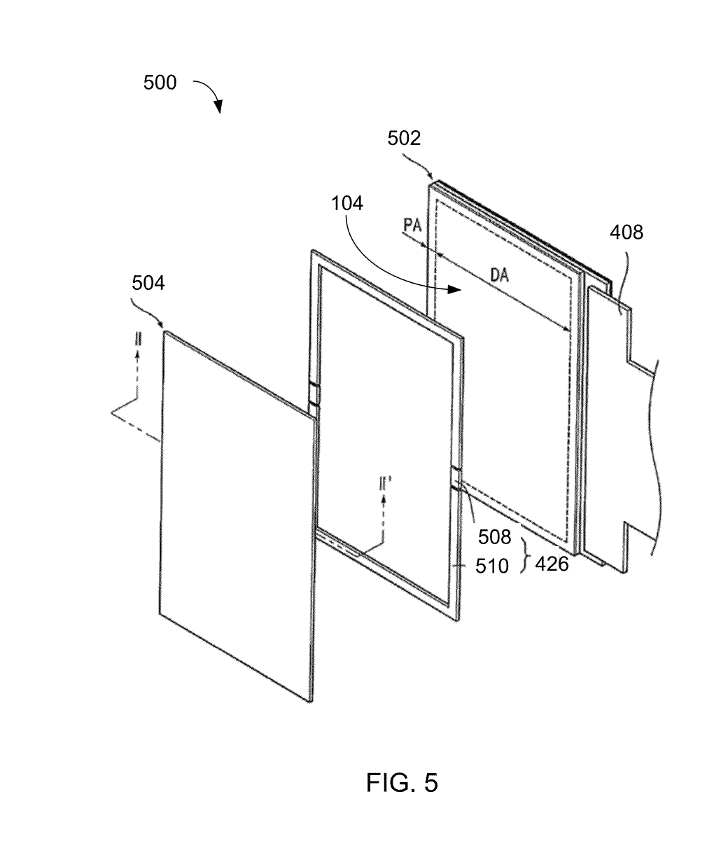

FIG. 5 is an exploded perspective view illustrating an exemplary touch-screen display device, in accordance with an embodiment of the present invention.

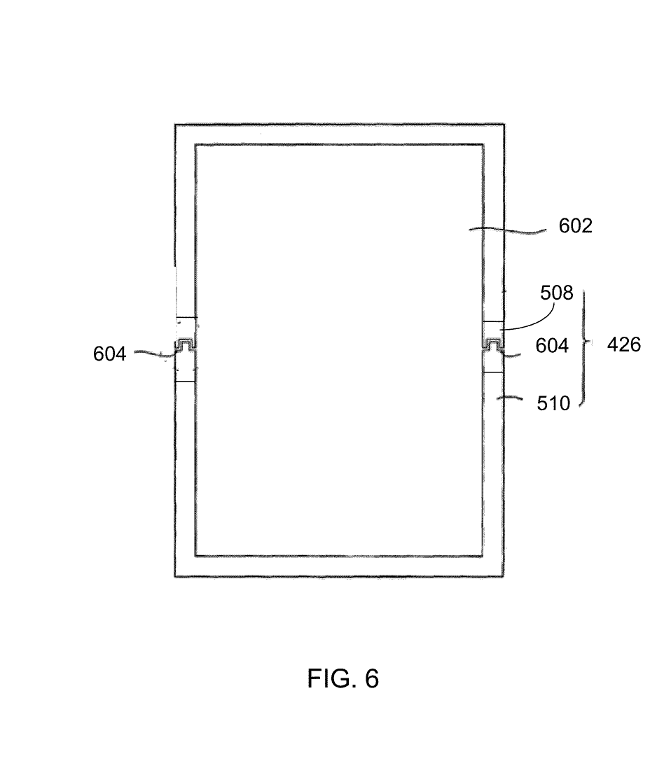

FIG. 6 is a plan view illustrating a portion of the exemplary touch-screen display device shown in FIG. 5, in accordance with an embodiment of the present invention.

Referring to FIGS. 5-6, a touch-screen display device 500 includes a display panel 502, electronic privacy filter 104, flexible printed circuit board 408, a first polarization film, a second polarization film 602, a touch panel 504, and adhesive member 426.

Accordingly, the first substrate, the second substrate, and the second polarization film 602 are sequentially disposed on the first polarization film, and the liquid crystal layer is interposed between the first and second substrates of the display panel 502.

The touch panel 504 is disposed separately from the second polarization film 602.

The adhesive member 426 is disposed between the second polarization film 602 and the touch panel 504 in correspondence to a peripheral area PA that is configured in the display panel 502. The adhesive member 426 attaches the display panel 502 to the touch panel 504. An airing path 604 is formed in the adhesive member 426. Accordingly, an air may be traversed from an exterior of the touch-screen display device 500 to the space between the touch panel 504 and the display panel 502 through the airing path 604. Alternatively, an air may be exhausted from the space between the touch panel 504 and the display panel 502 to an exterior of the touch-screen display device 500 through the airing path 604.

For example, without limitation, the adhesive member 426 may include a first adhesive tape 508 and a second adhesive tape 510 that are disposed along the peripheral area PA. As a non-limiting example, first adhesive tape 508 and second adhesive tape 510 may be configured as a film.

The first adhesive tape 508 may have a C-shape, and may be disposed in a short side peripheral area PA of the display panel 502. Two first end portions of the first adhesive tape 508 are extended to a central portion of a long side peripheral area PA of the display panel 502 along the peripheral area PA.

The second adhesive tape 510 may also have a C-shape. The second adhesive tape 510 is disposed in a short side peripheral area PA that faces a short side that is disposed in the first adhesive tape 508. Two second end portions of the second adhesive tape 510 are extended to a central portion of a long side peripheral area PA of the display panel 502 to face the first end portions of the first adhesive tape 508 along the peripheral area PA.

While FIGS. 5-6 illustrate the adhesive member 426 as having a pair of first adhesive tape 508 and second adhesive tape 510 forming a pair of airing paths 604 there between, it should be understood that an alternate number of airing paths 604 and a corresponding alternate number of adhesive tapes may be formed in the touch-screen display device 500. Also, while the airing paths 604 are shown as disposed on central portions of the long sides of the peripheral area PA, alternate positioning of the airing paths 604 along the peripheral area PA would also be within the scope of these embodiments.

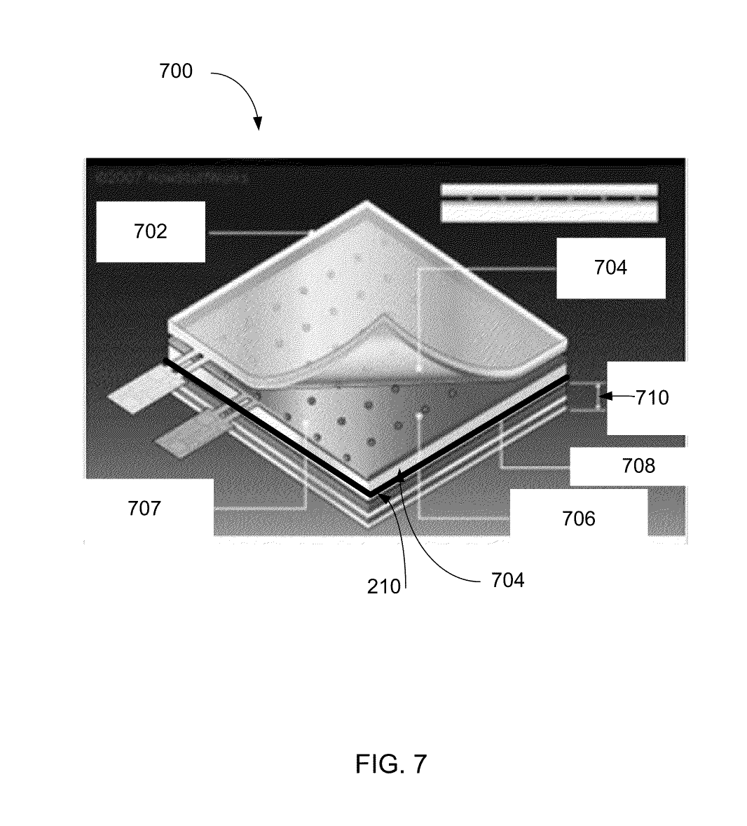

FIG. 7 is a perspective view illustrating an exemplary touch-screen display device, in accordance with an embodiment of the present invention.

A touch-screen display device 700 includes a flexible transparent surface 702, a transparent conductive layer 704, a multiplicity of non-conductive separator dots with a sampling noted as a non-conductive separator dot 706, a transparent conductive layer 707, a glass substrate 708, layers 210 and a LCD display layers portion 710.

Touch-screen display device 700 enables detection for simultaneous touch points in a multiplicity of different locations with respect to flexible transparent surface 702 while providing privacy associated with viewing the touch-screen display device 700.

Flexible transparent surface 702 provides for protection for lower layers. Furthermore flexible transparent surface 702 enables viewing information presented below flexible transparent surface 702. Transparent conductive layer 704 enables reception of touches performed above transparent conductive layer 704 for determining location of touch. Transparent conductive layer 704 enables viewing information presented below transparent conductive layer 704. Non-conductive separator dot 706 provides for separation and as a non-conductive path between transparent conductive layer 704 and transparent conductive layer 707. Glass substrate 708 provides a non-conductive layer between transparent conductive layer 707 and layers 210. Furthermore, glass substrate 708 enables viewing information presented below glass substrate 708. Layers 210 provides an electronically activated material for providing privacy filtering. LCD display layers portion 710 provides for presentation of visual information.

In operation, user (not shown) may select to touch flexible transparent surface 702 in a multiplicity of positions with the location of the multiplicity of touches decoded via transparent conductive layer 704 and transparent conductive layer 707. Furthermore, user may select to enable privacy filtering via layers 210. Configuration of privacy filtering may be selected via interface with flexible transparent surface 702.

FIG. 7 is a perspective view illustrating an exemplary touch-screen display device where multiple conductive layers enable determining location of a multiplicity of touches.

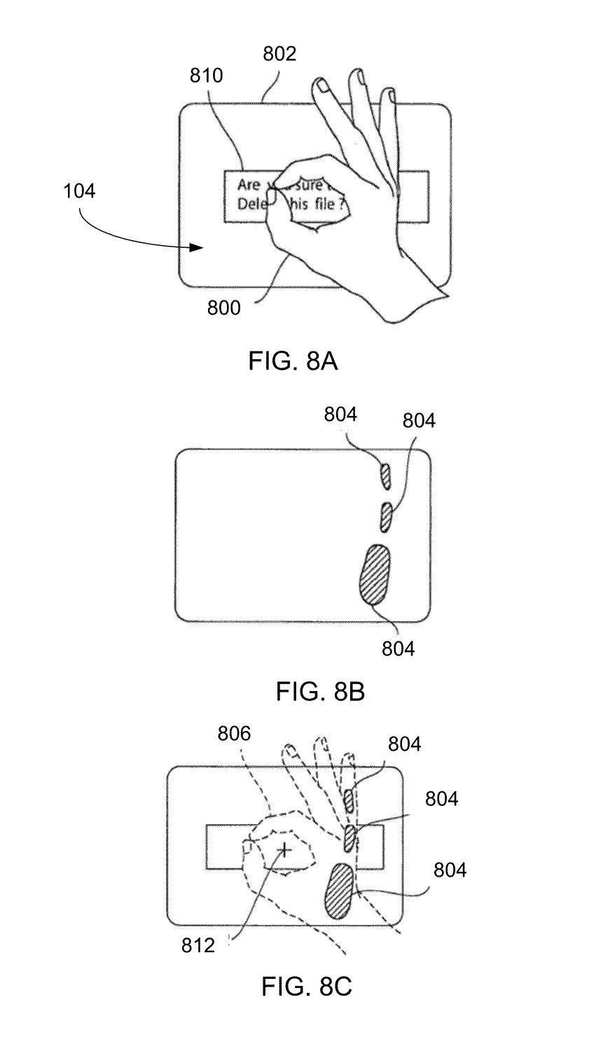

FIGS. 8A-C illustrate an exemplary “OK gesture” for performing recognition, in accordance with an embodiment of the present invention.

Display device includes electronic privacy filter 104 which may be configured on top of the presentation area or embedded within layers below the top layer. Those skilled in the art will appreciate that from a theoretical point of view, one potential theory of operation is that the touch screen may be considered as one plate of an open ended capacitor and a person's finger may be considered as the other plate. The dielectric between the touch screen and the finger is air with the distance between the touch screen and the person's finger considered as the distance between the plates of a capacitor. Hence, to help enable undiminished operation, if the privacy screen material is configured of a material and thickness to result in an effective dielectric constant close to the dielectric of air and its thickness is less than the maximum hover distance of the hover touch sensor, then this privacy touch screen design could be engineered, without undue experimentation, to properly support acceptable hover operation and privacy screen operation.

As a usage example, an “OK gesture” formed by either hand over a touch or hover sensitive device can be detected and interpreted to perform operations requiring an affirmative response, such as a text box User Interface (UI) element that asks the user whether a certain action is to be taken (e.g. “Are you sure you want to delete this file?”).

To detect an “OK gesture,” either a touch sensor panel with some hover detecting capability or a touch sensor panel co-located with a proximity sensor panel can be employed. FIG. 8A illustrates an exemplary orientation of a right hand 800 giving an “OK gesture” over a UI element 810 appearing beneath a sensor panel 802. In some embodiments, the thumb and index finger in the “OK” gesture can touch the sensor panel. Note that although single-hand gestures are generally described and illustrated as right-handed operations, it should be understood that embodiments are equally applicable to left-handed operations.

In FIG. 8B, the image of an actual touch 804 may not look like an “OK gesture”, due to the user's thumb, index finger, “pinky” finger and palm edge making contact with the sensor panel. However, if a sensor panel with sufficient near-field and/or far-field sensitivity is utilized, the image can appear more like that shown in FIG. 8C, with a large amount or a small mount of an index finger/thumb portion 806 being detected. Actual touch 804 can have a much higher “magnitude” or z-component as compared to index finger/thumb portion 806, due to actual touch 804 being closer to the sensor panel. In some embodiments, the image of actual touch 804 can be detected by a touch sensor panel, while the image of index finger/thumb portion 806 can be detected by a co-located proximity sensor panel. The images of actual touch 804 and index finger/thumb portion 806 can together be converted into a single feature as described above, or the images can be converted into two separate but overlapping features if image magnitude values are used to separate the two features.

If a single feature is found, and the various characteristics indicative of an “OK gesture” are present. As a non-limiting example, either images of actual touch 804 of FIG. 8B, or a “finger circle” portion including an image of weak touch or a hover of index finger/thumb portion 806 that completely or almost completely encircles a region of no detected touch, or a hover of index finger/thumb portion 806, in combination with one or more adjacent longer and tapering “palm edge and pinky” images of actual touch 804, then that feature can be classified as an “OK gesture.” As a non-limiting example, for two features found, one feature can be classified as a “palm edge and pinky” feature and the other feature can be classified as a “thumb/index finger” feature or a “finger circle” feature, with the features being grouped together. The grouping can then be analyzed to determine if the grouping indicates that a hand forming an “OK gesture” is present.

After the features have been classified and grouped, parameters for the group can be computed, such as an approximate center 812 of the region of no detected touch or hover, and if this center is located coincident with the UI element 810 (FIG. 8A), the UI element can be associated with the group. An appropriate action can then be taken. In the present example, the detection of an “OK gesture” image coincident with the “Are you sure you want to delete this file?” text box can cause the file to be deleted.

FIGS. 8A-C illustrate an exemplary “OK gesture” for performing recognition where privacy filtering may be performed.

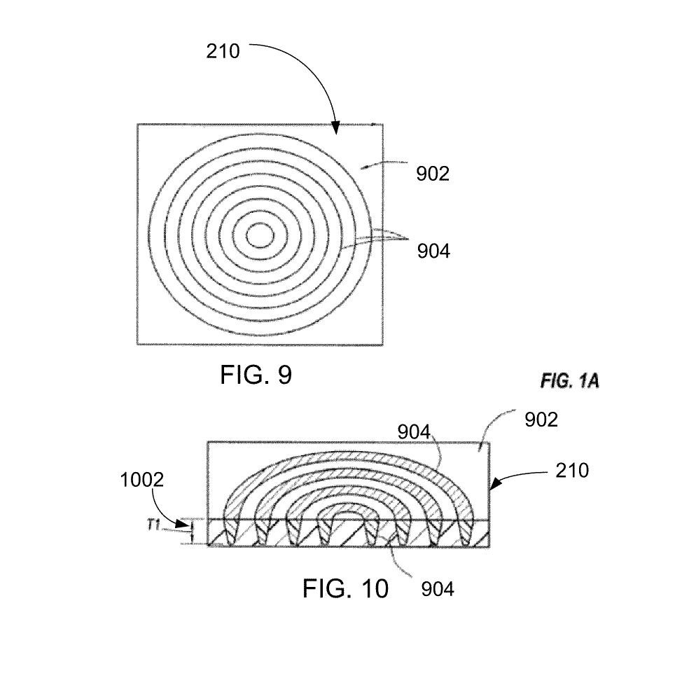

FIG. 9 illustrates an alternative embodiment of the privacy filter described with reference to FIG. 2, in accordance with an embodiment of the present invention.

As shown, the layers 210 comprises a film 902 enabling light traversal. Film 902 enables transmission of light and appears transparent to a user so that, when the layers 210 is associated with a display (e.g., computer monitor), the user can read the information provided via the display. Film 902 comprises a plurality of optically opaque regions noted as an optically opaque portion 904. Optically opaque portion 904 comprises a self-contained shape, at least a portion of which in the plane defined by film 902 has a curved portion. In some embodiments, the entirety of the optically opaque region is curved and/or is rounded. In the embodiment of FIG. 9, the optically opaque portion 904 is circular, but in general can be any shape. Furthermore, a portion may be curved, such as elliptical, circular, and oval. In some embodiments, optically opaque portion 904 comprises a plurality of concentrically arranged regions. In other embodiments, the optically opaque portion 904 is a single spiral groove.

The regions associated with optically opaque portion 904 are generally thin, and thus when layers 210 is viewed orthogonal to the plane of the filter, the optically opaque regions generally are not viewable. As such, a user can view the display through the layers 210 generally unimpeded by the regions associated with optically opaque portion 904.

FIG. 9 illustrates an alternative embodiment of the privacy filter described with reference to FIG. 2 where opaque regions enable privacy filtering.

FIG. 10 illustrates an exaggerated, cross-sectional, perspective view of the film described with reference to FIG. 9, in accordance with an embodiment of the present invention.

Optically opaque portion 904 extends into the surface of the film 902 albeit preferably not traversing through the film. Optically opaque region comprises a groove having a tapered shape as shown. A suitable optically opaque material is disposed in the grooves. Examples of suitable optically opaque materials comprise light absorbing materials or light blocking materials. Suitable materials include a black dye.

Film 902 can be made from any suitable light transparent material into which the grooves containing the optically opaque material can be formed. As a non-limiting example, film 902 may be configured of plastic. As a non-limiting example, film 902 may be molded, cast, extruded or otherwise machined to have the plurality of grooves into which the optically opaque material is deposited (e.g., filled, coated, etc.).

The side walls of the tapered grooves in FIG. 10 can be flat as shown or, in other embodiments, curved. The rounded nature of the regions associated with optically opaque portion 904 explained refers to the shape of the regions when viewed from the top as in FIG. 9. Furthermore, the shape of the grooves across the surface of the film may be rounded.

In some embodiments, a single layer of film 902 is suitable for providing lateral and vertical privacy. When a user views the layers 210 from an angle that differs substantially from 90 degrees, the user is unable to adequately see through the layers 210 due to a thickness 1002 also noted as T1 of the regions associated with optically opaque portion 904. The rounded (e.g., elliptical) nature of the optically opaque regions provides privacy from an errant gaze from the sides, top or bottom. The spacing between, and the thickness of, the optically opaque regions configures the viewing angle of the layers 210 (the angle through which filter permits adequate viewing).

The addition of the privacy filter technique shown in FIGS. 9-10 does not significantly impede touch pad sensitivity or resolution, as the regions associated with optically opaque portion 904 are generally thin such that they are flexible and act as flexible joints between the thin grooves. The stiffness of the privacy film may be configured in order to allow high resolution deformation of film 902 so as to not impede touch screen performance. Moreover, the dielectric constant operation theory above for the embodiment of FIGS. 8A-C similarly may be applied to this embodiment as well. That is, to achieve a certain level of touchpad and privacy filter performance the designer would adjust the height and width of, and distance between the opaque regions depending on the type of touch screen and angles of privacy needed. For example, without limitation, for a tactile touch sensor, the opaque regions may be made thinner and further apart to not stiffen the touch pad significantly, and in standard capacitive touch sensor the opaque regions might be made with less distance between them to increase the privacy viewing angle and decrease the height as needed to maintain the maximum capacitive sensing specification of the touch sensor. For the hover sensor embodiment, as described with reference to FIGS. 8A-C, the film may be configured with an increased height for the opaque regions to a more normal range and thereby increase the privacy filter functionality while maintaining acceptable touch sensing functionality.

In alternative embodiments, instead of being a separate layer on top of the touch sensor, the regions associated with optically opaque portion 904 may be formed onto the touch screen material directly. That is, instead of forming optically opaque portion 904 onto film 902, they may be configured in the touch screen exposed surface material, which would eliminate the thickness (and cost) penalty of film 902.

FIG. 10 illustrates an exaggerated, cross-sectional, perspective view of the film described with reference to FIG. 9 which provides privacy filtering capability.

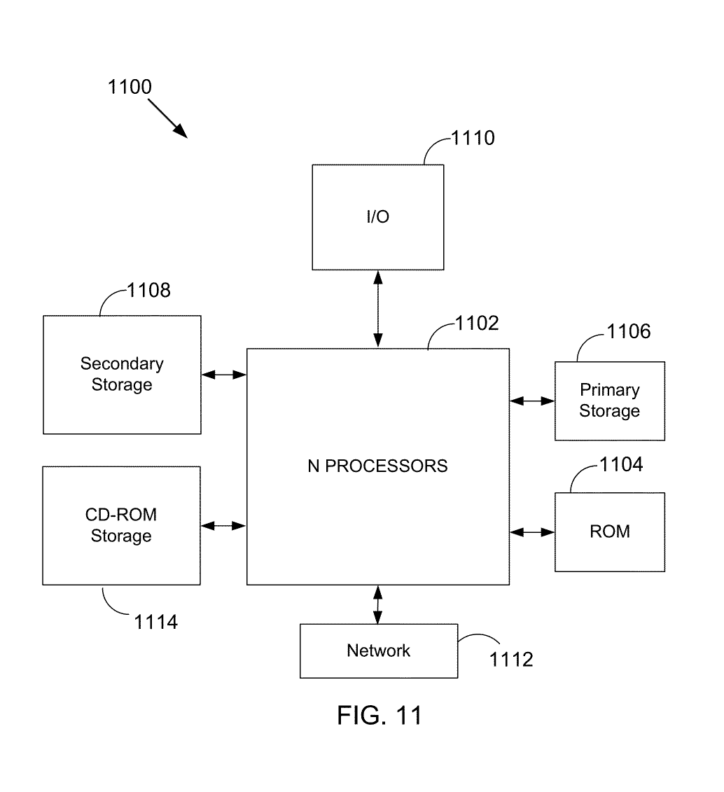

FIG. 11 illustrates a typical computer system that, when appropriately configured or designed, may serve as a computer system 1100 for which the present invention may be embodied.

Computer system 1100 includes a quantity of processors 1102 (also referred to as central processing units, or CPUs) that may be coupled to storage devices including a primary storage 1106 (typically a random access memory, or RAM), a primary storage 1104 (typically a read-only memory, or ROM). CPU 1102 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. As is well known in the art, primary storage 1104 acts to transfer data and instructions uni-directionally to the CPU and primary storage 1106 typically may be used to transfer data and instructions in a bi-directional manner. The primary storage devices discussed previously may include any suitable computer-readable media such as those described above. A mass storage device 1108 may also be coupled bi-directionally to CPU 1102 and provides additional data storage capacity and may include any of the computer-readable media described above. Mass storage device 1108 may be used to store programs, data and the like and typically may be used as a secondary storage medium such as a hard disk. It will be appreciated that the information retained within mass storage device 1108, may, in appropriate cases, be incorporated in standard fashion as part of primary storage 1106 as virtual memory. A specific mass storage device such as a CD-ROM 1114 may also pass data uni-directionally to the CPU.

CPU 1102 may also be coupled to an interface 1110 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1102 optionally may be coupled to an external device such as a database or a computer or telecommunications or internet network using an external connection shown generally as a network 1112, which may be implemented as a hardwired or wireless communications link using suitable conventional technologies. With such a connection, the CPU might receive information from the network, or might output information to the network in the course of performing the method steps described in the teachings of the present invention.

In some embodiments, a mirror function may be implemented where the portions of the screen that is being blocked off to the public by the privacy screen shows as a mirror, or have a “mirror effect”. In other embodiments, that same portions of the screen may show as a picture, logo, personal message, or whatsoever is desired. In some other embodiments, a user may set privacy filter to a timer to allow for privacy filter to be shut off after permitted time is expired, or to be set to turn on during specific times of the day. In a non-limiting example, privacy filter may be set to automatically turn on at 3 pm daily or turn off at 3 pm daily. In another embodiment, may set privacy filter to run during use of specific applications. In a non-limiting example, privacy filter may be set to automatically turn on whenever a web browser or communication application such as texting is in use. In another non-limiting example the privacy filter may be set to automatically turn off whenever a camera application is in use. In some other embodiments, the privacy filter may have ability to set reminders for specific applications. In a non-limiting example, if a web browser application is selected for use, a “pop up” window would appear to ask permission to turn on privacy filter before use.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of a privacy filtering system according to the present invention will be apparent to those skilled in the art. The invention has been described above by way of illustration, and the specific embodiments disclosed are not intended to limit the invention to the particular forms disclosed. For example, the particular implementation of the touch-screen may vary depending upon the particular type of computing device used. The computing devices described in the foregoing were directed to smartphone implementations; however, similar techniques for cellular telephone, ATM (Automated Teller Machine), airport self check-in kiosks, gas station “pay at pump” monitors, and grocery store self check-out registers implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. An integrated privacy filter comprising:
a multilayer display portion comprising a panel comprising a front display surface, said multilayer display portion further comprising a native viewing angle;
an electronically activated material layer being disposed above said front display surface to substantially cover at least an active display area of said multilayer display portion in which said electronically activated material layer is integrated with said multilayer display portion and activation of said electronically activated material layer alters said native viewing angle; and
a touch screen portion being disposed above said electronically activated material layer, said touch screen portion being configured to at least react to touch inputs from a user and to substantially cover said active display area.

2. The integrated privacy filter as recited in claim 1, in which said multilayer display portion comprises at least a first layer at least in part determining said native viewing angle.

3. The integrated privacy filter as recited in claim 2, in which said multilayer display portion comprises at least a second layer at least in part determining said native viewing angle.

4. The integrated privacy filter as recited in claim 3, in which said electronically activated material layer is disposed between said first and second layers.

5. The integrated privacy filter as recited in claim 1, in which said touch screen portion is separated from said electronically activated material layer by an air gap.

6. The integrated privacy filter as recited in claim 5, further comprising an adhesive member disposed about a periphery of said active display area to form said air gap.

7. The integrated privacy filter as recited in claim 1, in which activation of said electronically activated material layer variably alters said native viewing angle.

8. The integrated privacy filter as recited in claim 1, in which activation of said electronically activated material layer is by application program.

9. The integrated privacy filter as recited in claim 1, in which activation of said electronically activated material layer is by user interaction with said touch screen portion.

10. The integrated privacy filter as recited in claim 1, in which said multilayer display portion further comprises a liquid crystal.

11. The integrated privacy filter as recited in claim 10, in which said electronically activated material layer comprises a polymer dispersed liquid crystal material for increasing said native viewing angle.

12. The integrated privacy filter as recited in claim 10, in which said electronically activated material layer comprises a twisted nematic liquid crystal material for decreasing said native viewing angle.

13. An integrated privacy filter comprising:
means for displaying with a native viewing angle;
means being integrated with said displaying means for altering said native viewing angle; and
means, covering said altering means, for touch interaction.

14. The integrated privacy filter as recited in claim 13, further comprising means for activating said altering means.

15. An integrated privacy filter comprising:
a multilayer liquid crystal display portion comprising a panel comprising a front display surface, said multilayer liquid crystal display portion further comprising a first polarization layer and a second polarization layer, said first polarization layer and said second polarization layer at least in part determining a native viewing angle;
an electronically activated material layer being disposed above said front display surface to substantially cover at least an active display area of said multilayer liquid crystal display portion in which said electronically activated material layer is integrated with said multilayer liquid crystal display portion and activation of said electronically activated material layer variably alters said native viewing angle;
an adhesive member disposed about a periphery of said active display area above said electronically activated material layer; and
a touch screen portion being joined to said adhesive member above said electronically activated material layer in which an air gap is formed between said touch screen portion and said electronically activated material layer, said touch screen portion being configured to at least react to touch inputs from a user and to substantially cover said active display area.

16. The integrated privacy filter as recited in claim 15, in which said electronically activated material layer is disposed between said first and second layers.

17. The integrated privacy filter as recited in claim 15, in which activation of said electronically activated material layer is by application program.

18. The integrated privacy filter as recited in claim 15, in which activation of said electronically activated material layer is by user interaction with said touch screen portion.

19. The integrated privacy filter as recited in claim 15, in which said electronically activated material layer comprises a polymer dispersed liquid crystal material for increasing said native viewing angle.

20. The integrated privacy filter as recited in claim 15, in which said electronically activated material layer comprises a twisted nematic liquid crystal material for decreasing said native viewing angle.
